(19) United States
(12) Patent Application Publication
(10) Pub. No.: US 2018/0335061 A1
(43) Pub. Date: Nov. 22, 2018

(54) COUPLER FOR CONNECTING REINFORCING STEEL BARS

(71) Applicants: Chi Sung SONG, Busan (KR); DAEHAN Precision Industry co., Ltd., Yangsan-si (KR)

(72) Inventor: Chi Sung SONG, Busan (KR)

(73) Assignees: DAEHAN Precision Industry co., Ltd., Yangsan-si (KR); Chi Sung SONG, Busan (KR)

(21) Appl. No.: 15/683,234

(22) Filed: Aug. 22, 2017

(30) Foreign Application Priority Data
May 18, 2017 (KR) 10-2017-0061522

(51) Int. Cl. F16B 7/04; F16B 2/06

(52) U.S. Cl. CPC F16B 7/0426; F16B 2/06

(57) ABSTRACT

A coupler for connecting reinforcing steel bars is capable of connecting a plurality of reinforcing steel bars by installing a plurality of clamping members inside a cylindrical coupler bodies to be in close contact with outer surfaces of the plurality of reinforcing steel bars, and two pressurizing members configured to pressurize the clamping members to the inlets and tightly contact the clamping members to the tapered parts of the coupler bodies. The pressurizing members are pressed and fitted inside the coupler bodies by the hydraulic device, and are firmly supported by the fixing pin to be prevented from escaping to the outside of the coupler bodies such that a spring back phenomenon does not occur and a phenomenon in which a force of the clamping members for fixing the reinforcing steel bars are weakened does not occur.

### CROSS-REFERENCE TO RELATED APPLICATION

This application claims priority to and the benefit of Korean Patent Application No. 10-2017-0061522, filed on May 18, 2017, the disclosure of which is incorporated herein by reference in its entirety.

### BACKGROUND

### 1. Field of the Invention

The present disclosure relates to a coupler for connecting reinforcing steel bars, and more particularly, to a coupler for connecting reinforcing steel bars, which is capable of connecting a plurality of reinforcing steel bars by installing a plurality of clamping members, which are in close contact with outer surfaces of the plurality of reinforcing steel bars, inside a cylindrical main body at which an insertion hole into which a reinforcing steel bar is inserted is formed at both ends of the cylindrical main body, to firmly fix the plurality of reinforcing steel bars.

### 2. Discussion of Related Art

To connect reinforcing steel bars for use in a concrete construction at construction sites, the reinforcing steel bars are typically bound and fixed by a steel wire in a state in which the reinforcing steel bars are doubly stacked in. However, in such a reinforcing steel bar fixing method, since an outer circumference of the doubly stacked reinforcing steel bars is wound a number of times with the steel wire to be bound by a worker, this work is cumbersome and the center of each of the doubly stacked reinforcing steel bars is neither vertical nor straight and also strength of the steel wire is weak such that a problem in which the steel wire is easily broken and thus the connection state between the doubly stacked reinforcing steel bars is released occurs.

To resolve the above-described problem, instead of the steel wire, reinforcing steel bar joint devices (reinforcing steel bar couplers) configured to easily and firmly connect reinforcing steel bars have been developed and used.

However, since most of the developed typical reinforcing steel bar couplers employs a method in which reinforcing steel bars are inserted and fixed inside a housing by screwing the housing, a structure thereof is complicated and a work for connecting the reinforcing steel bars is difficult such that a problem in which times, efforts, and costs are much required for that work occurs.

To resolve the above-described problem, one-touch type reinforcing steel bar couplers, which are easily connecting reinforcing steel bars, are disclosed in Korean Registered Patent Nos. 10-0439305 (registered on Jun. 28, 2004), 10-0462291 (registered on Dec. 8, 2004), and 10-1003302 (registered on Dec. 16, 2010)

However, since such typical reinforcing steel bar couplers have a weak force for holding reinforcing steel bars, when a strong tensile force is applied to the reinforcing steel bars, there is a concern that the reinforcing steel bars escape to be separated from the typical reinforcing steel bar couplers.

Thus, Korean Registered Patent No. 10-1375535 discloses a reinforcing steel bar coupler in which a through-hole is formed at a side surface of a main body to pass therethrough, and a conical pressurizing member is inserted through the through-hole and then is strongly inserted inside the main body using a hydraulic device, so that a clamping member (a reinforcing steel bar fixing member) is able to fix a reinforcing steel bar with a strong force.

However, since the pressurizing member of the reinforcing steel bar coupler disclosed in the above-described Korean Registered Patent is formed in a conical shape, a problem in which the pressurizing member is pushed again to the outside of the through-hole due to a spring back phenomenon occasionally occurs.

### PRIOR ART DOCUMENT

### Patent Documents

(Patent Document 1) Korean Registered Patent No. 10-1375535 (registered on Mar. 10, 2014)
(Patent Document 2) Korean Registered Patent No. 10-0439305 (registered on Jun. 28, 2004)
(Patent Document 3) Korean Registered Patent No. 10-0462291 (registered on Dec. 8, 2004)
(Patent Document 4) Korean Registered Patent No. 10-1003302 (registered on Dec. 16, 2010)

### SUMMARY OF THE INVENTION

An objective of the present disclosure, which is to resolve the above-described problem, is to provide a coupler for connecting reinforcing steel bars, which is capable of firmly holding and connecting the reinforcing steel bars by inserting a pressurizing member configured in a conical shape by a hydraulic device and then allowing the pressurizing member not to be pushed again to the outside and to be maintained in the inserted state.

To attain the above-describe objective, a coupler for connecting reinforcing steel bars according to the present disclosure includes a first coupler body and a second coupler body which include hollow parts having inlets formed at final end portions of the hollow parts and into which the reinforcing steel bars are inserted, and having tapered parts of which each diameter gradually increases from the inlet to a side opposite thereto, and a plurality of through-holes formed to face each other at side surfaces of the first coupler body and the second coupler body; a first clamping member and a second clamping member which are configured with a plurality of clampers having outer surfaces installed to be in contact with the tapered parts inside the hollow parts of the first and second coupler bodies, and at which a plurality of clamping protrusions are disposed on inner surfaces of the plurality of clampers to hook and support nodes of the reinforcing steel bars; a plurality of pressurizing members having a conical shape and a pin insertion hole formed to pass through central portions of each of the plurality of pressurizing members, inserted through the plurality of through-holes by a hydraulic device, and configured to pressurize the first clamping member and the second clamping member toward the inlets and tightly contact the first clamping member and the second clamping member to the tapered parts; and a fixing pin inserted through the pin insertion hole of the plurality of pressurizing members, and configured to simultaneously support the plurality of pressurizing members.

### BRIEF DESCRIPTION OF THE DRAWINGS

The above and other objects, features and advantages of the present disclosure will become more apparent to those of ordinary skill in the art by describing exemplary embodiments thereof in detail with reference to the accompanying drawings, in which:

FIG. 1 is an exploded perspective view of a coupler for connecting reinforcing steel bars according to one embodiment of the present disclosure;

FIG. 2 is a cross-sectional view of the coupler for connecting reinforcing steel bars illustrated in FIG. 1, and illustrates a state before reinforcing steel bars are connected;

FIG. 3 is a cross-sectional view of the coupler for connecting reinforcing steel bars illustrated in FIG. 1, and illustrates a state after the reinforcing steel bars are connected;

FIG. 4 is a perspective view of a hydraulic device configured to press and fit a pressurizing member of the coupler for connecting reinforcing steel bars illustrated in FIG. 1;

FIG. 5 is a cross-sectional view of an essential part of the hydraulic device illustrated in FIG. 4; and

FIGS. 6A and 6B are perspective views each illustrating examples of hydraulic pressure tools of the hydraulic device illustrated in FIG. 4.

### DETAILED DESCRIPTION OF EXEMPLARY EMBODIMENTS

Hereinafter, a preferred embodiment of a coupler for connecting reinforcing steel bars according to the present disclosure will be described in detail with reference to the accompanying drawings.

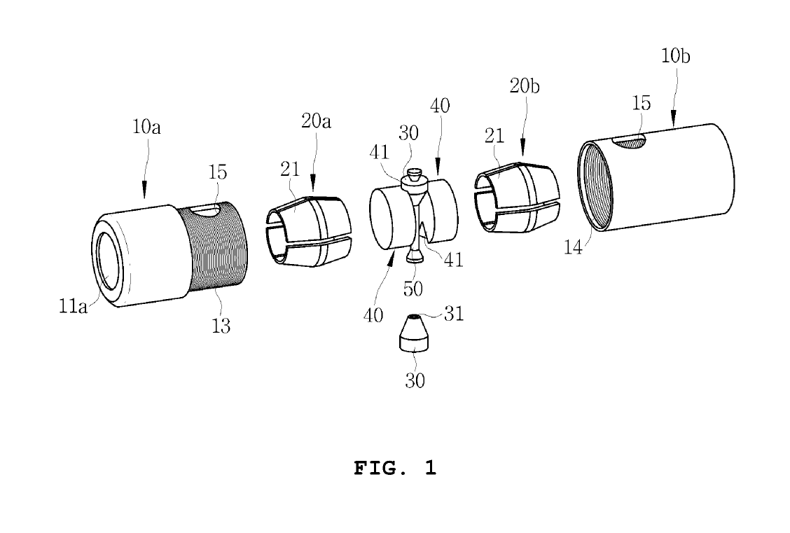

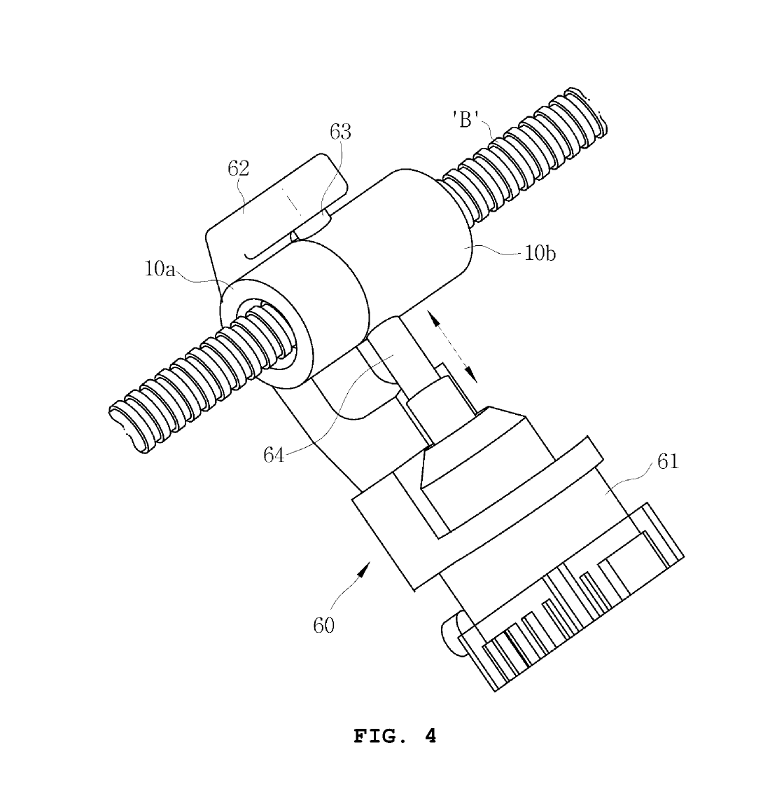

Referring to FIGS. 1 to 5, the coupler for connecting reinforcing steel bars according to one embodiment of the present disclosure is configured to include a first coupler body 10a and a second coupler body 10b which each are configured in a cylindrical pipe shape, a first clamping member 20a and a second clamping member 20b which each are symmetrically installed inside the first coupler body 10a and the second coupler body 10b and serve to firmly hold reinforcing steel bars B, a plurality of pressurizing members 30 (for example, two pressurizing members 30 in the present embodiment) inserted through a plurality of through-holes 15 (for example, two through-holes 15 in the present embodiment) formed at side surfaces of the first coupler body 10a and the second coupler body 10b and configured to pressurize and tightly contact the first clamping member 20a and the second clamping member 20b to tapered parts 12, a fixing pin 50 inserted through a pin insertion hole 31 of the plurality of pressurizing members 30 and configured to simultaneously support the plurality of pressurizing members 30, and a ring-shaped spacer 40 installed between final end portions of the first clamping member 20a and the second clamping member 20b, and side surfaces of the plurality of pressurizing members 30.

The first coupler body 10a is made of a solid metal material, and is provided with a hollow part 11 at which an inlet 11a, into which the reinforcing steel bar B is inserted, is formed at one end portion of the hollow part 11, and the tapered part 12 having an inner diameter gradually narrowing from the inlet 11a to a side opposite thereto is formed. A male screw thread 13 configured to couple to the second coupler body 10b is formed at an outer circumferential surface of the other end portion of the hollow part 11.

The second coupler body 10b has a shape corresponding to that of the first coupler body 10a. That is, the second coupler body 10b is provided with the hollow part 11 at which the inlet 11a, into which the reinforcing steel bar B is inserted, is formed at one end portion of the hollow part 11, and the tapered part 12 having an inner diameter gradually narrowing from an upper portion of the tapered part 12 to a lower portion thereof is formed. Also, a female screw thread 14 configured to couple to the first coupler body 10a is formed at an inner circumferential surface of an upper end portion of the hollow part 11.

The plurality of through-holes 15, into which the plurality of pressurizing members 30 are inserted, are formed at the side surfaces of the first coupler body 10a and the second coupler body 10b, and exactly, at portions where the male screw thread 13 and the female screw thread 14 are formed. The plurality of through-holes 15 are disposed to face one another at an interval of 180 degrees. Each of the plurality of through-holes 15 has a circular ball shape having a diameter corresponding to a maximum diameter of each of the plurality of pressurizing members 30.

The first clamping member 20a and the second clamping member 20b, which each are installed inside the hollow parts 11 of the first coupler body 10a and the second coupler body 10b, are disposed in a mutually symmetrical structure, and firmly hold reinforcing steel bars B, which are inserted inside the first coupler body 10a and the second coupler body 10b, to connect the reinforcing steel bars B to each other. The first clamping member 20a and the second clamping member 20b are configured in a mutually symmetrical configuration, and thus, for convenience of description, a configuration and an operation of the first clamping member 20a will be mainly described below.

The first clamping member 20a includes a plurality of clampers 21 (for example, four clampers 21 in the present embodiment) disposed along a circumferential direction of the first clamping member 20a, and a clamper support ring 25 being in contact with inner surfaces of the plurality of clampers 21 inside a space between the plurality of clampers 21 and configured to prevent the plurality of clampers 21 from moving.

The plurality of clampers 21 configuring the first clamping member 20a are installed inside the hollow part 11 of the first coupler body 10a, and outer surfaces of the plurality of clampers 21 are curved to correspond to and to be in contact with the tapered parts 12 of the hollow part 11. The plurality of clampers 21 have the same shape, and are coupled to the clamper support ring 25 to be maintained at regular intervals. The plurality of clampers 21 are positioned at a central portion of the hollow part 11 in a state in which the reinforcing steel bars B are not inserted into the first coupler body 10a, while, when the reinforcing steel bars B are inserted into the plurality of clampers 21 through the inlet 11a of the first coupler body 10a, the plurality of clampers 21 break to be in close contact with outer surfaces of the reinforcing steel bars B and then are pressurized by the plurality of pressurizing members 30 and are in close contact with the tapered parts 12, thereby firmly fixing the reinforcing steel bars B.

A plurality of clamping protrusions 22 are formed on the inner surfaces of the plurality of clampers 21 to hook and support nodes of the reinforcing steel bars B. The plurality of clamping protrusions 22 are disposed at regular pitch intervals along an axial direction of the first coupler body 10a, and preferably, the plurality of clamping protrusions 22 have a ratchet saw tooth shape so as to resist tensile forces applied from the nodes P of the reinforcing steel bars B and prevent the reinforcing steel bars B from escaping. The plurality of clamping protrusions 22 are preferably formed at pitch intervals of 1±0.05 millimeters (mm), but the pitch intervals may be varied according to a specification of a reinforcing steel bar.

The clamper support ring 25 is configured in a circular ring and supports the plurality of clampers 21, thereby allowing the plurality of clampers 21 to be maintained at predetermined gaps between the plurality of clampers 21 and at predetermined positions in a state in which the reinforcing steel bars B are not inserted therebetween.

Each of the plurality of pressurizing members 30 has a conical shape of which diameter narrows toward inside the hollow parts 11 of the first coupler body 10a and the second coupler body 10b, and the pin insertion hole 31 into which the fixing pin 50 is inserted is formed to pass through the plurality of pressurizing members 30 at a central portion thereof in an axial direction (that is, a vertical direction in the drawing). The plurality of pressurizing members 30 are inserted through the through-holes 15 by a hydraulic device 60, and serve to pressurize the first clamping member 20a and the second clamping member 20b toward the inlets 11a, thereby tightly contacting and fixing the first clamping member 20a and the second clamping member 20b to the tapered parts 12.

The fixing pin 50 has a long circular rod shape, is inserted through the pin insertion hole 31 of the plurality of pressurizing members 30, and supports to prevent the plurality of pressurizing members 30 from escaping from the inside of the hollow parts 11 of the first and second coupler bodies 10a and 10b. Both end portions of the fixing pin 50 protrude toward the outside of the plurality of pressurizing members 30 and then are conically widened by the hydraulic device 60 to prevent the plurality of pressurizing members 30 from escaping.

The fixing pin 50 may entirely have a hollow pipe shape, but, as in the present embodiment, a middle portion of the fixing pin 50 may have a pipe shape of which inner side is filled except for both of the end portions of the fixing pin 50, and only both of the end portions thereof may have a hollow pipe shape that is able to be conically widened. Further, in addition to a circular rod, the fixing pin 50 may be configured in a rod having a polygonal cross section, such as a square rod, a hexagonal rod, or the like.

In the present embodiment, both of the end portions of the fixing pin 50 are conically widened to prevent the plurality of pressurizing members 30 from escaping from the fixing pin 50, but screw threads are formed on outer surfaces of both of the end portions of the fixing pin 50, which protrude toward the outside of the plurality of pressurizing members 30, and nuts are engaged with both of the end portions of the fixing pin 50 so that the plurality of pressurizing members 30 may be prevented from escaping from the fixing pin 50.

The spacers 40 are configured in a circular ring shape, and are positioned between the first clamping member 20a and the second clamping member 20b, and the plurality of pressurizing members 30. Receiving recesses 41 are formed on one surfaces of the spacers 40 being in contact with the plurality of pressurizing members 30, and are in close contact with the side surfaces of the plurality of pressurizing members 30 in a form corresponding to the side surfaces thereof.

Since the spacers 40 are positioned between the first clamping member 20a and the second clamping member 20b, and the plurality of the pressurizing members 30, a contact force is delivered from the plurality of the pressurizing members 30 to the receiving recesses 41 formed on the one surfaces of the spacers 40, and then is delivered to the first clamping member 20a and the second clamping member 20b which are in contact along circumferences of the other surfaces of the spacers 40. At this point, since one end portions of the plurality of clampers 21 configuring the first clamping member 20a and the second clamping member 20b are in contact along the circumferences of the spacers 40, the one end portions of the clampers 21 serve to distribute a force generated due to pressing and fitting of the plurality of pressurizing members 30, thereby stably fixing the reinforcing steel bars B. In such a structure, since one final end surfaces of the plurality of clampers 21, which are separated from one another, are simultaneously in surface-to-surface contact with the one surfaces of the spacers 40 to deliver a force to the spacers 40, the above-described structure provides an advantage capable of more stably delivering the force to the plurality of clampers 21 to fix the reinforcing steel bars B.

Further, the one surfaces of the spacers 40, which are in contact with the final end portions of the clampers 21 of the first clamping member 20a and the second clamping member 20b, are formed to be inclined toward the plurality of pressurizing members 30 as being toward an inner side of a radius direction. For convenience of description, the inclined surfaces being in contact with the final end portions of the clampers 21 will be described by being referred to as inclined contact surfaces 42. When the force from the plurality of pressurizing members 30 is delivered to the clampers 21 of the first clamping member 20a and the second clamping member 20b through the spacers 40, the inclined contact surfaces 42 deflect the final end portions of the clampers 21 to the central portions of the hollow parts 11 to provide an advantage capable of more firmly holding the reinforcing steel bars B.

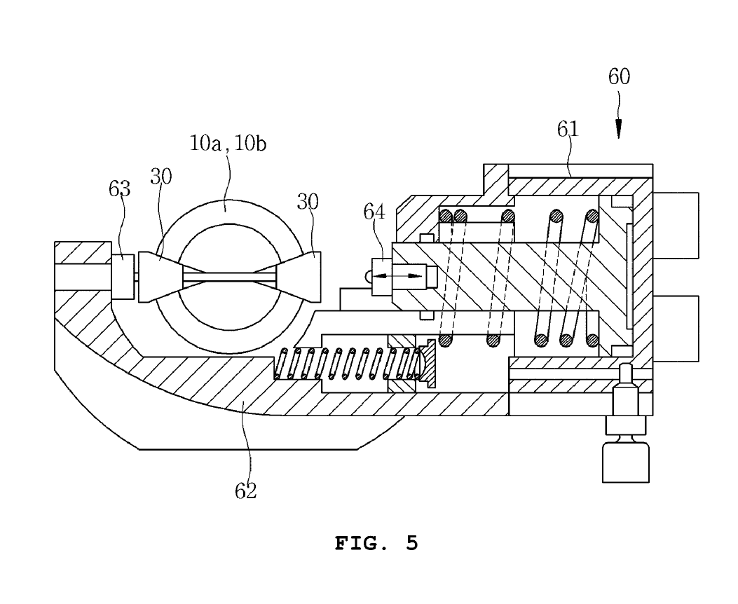

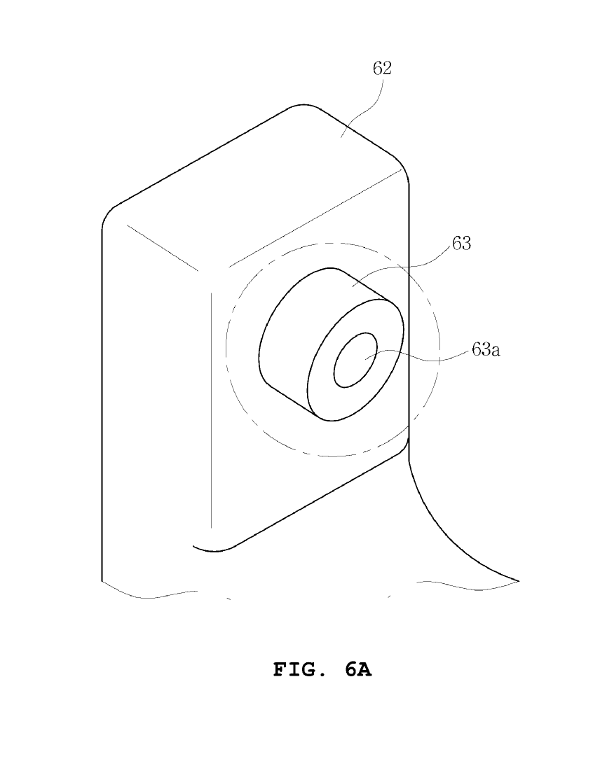

The hydraulic device 60 is configured to simultaneously insert the plurality of pressurizing members 30 through the through-holes 15 of the first coupler body 10a and the second coupler body 10b, and simultaneously conically widen both of the end portions of the fixing pin 50. Referring to FIGS. 4 and 5, the hydraulic device 60 is configured with a structure in which an approximately U-shaped support head 62 is installed at one end portion of a main body 61 to which a hydraulic pressure is supplied, a fixed hydraulic pressure tool 63 is disposed at an outer end portion of the support head 62 and is in close contact with the outer surface of the pressurizing member 30 that is inserted into one of the through-holes 15 of the first coupler body 10a and the second coupler body 10b, and a moving hydraulic pressure tool 64 is disposed at an inner end portion of the support head 62 and slides due to the hydraulic pressure supplied inside the main body 61 to pressurize the pressurizing member 30, which is inserted into the other one of the through-holes 15 of the first coupler body 10a and the second coupler body 10b, to the fixed hydraulic pressure tool 63 with a strong pressure.

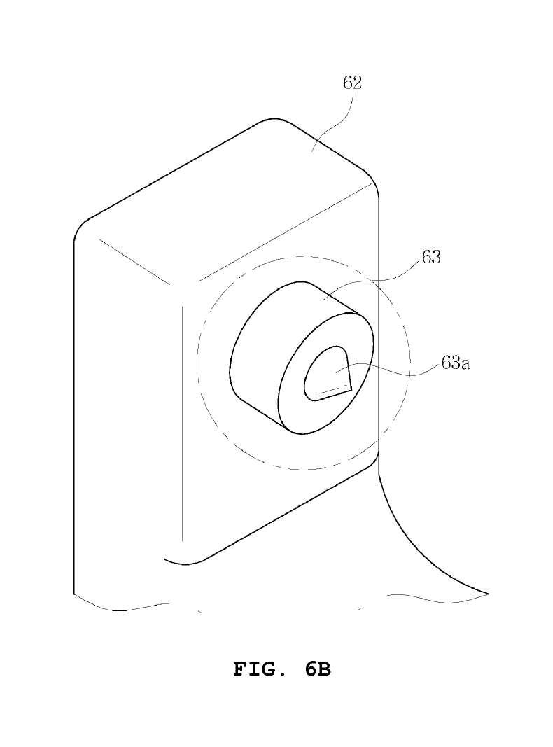

When pressurizing the plurality of pressurizing members 30, the fixed hydraulic pressure tool 63 and the moving hydraulic pressure tool 64 have a cylindrical block shape at which a pin receiving hole 63a is formed at a central portion of the cylindrical block shape as illustrated in FIG. 6A, and, when pressurizing and widening both of the end portions of the fixing pin 50, the fixed hydraulic pressure tool 63 and the moving hydraulic pressure tool 64 have a block shape at which a widening conical portion 63b protrudes from a central portion of the block shape as illustrated in FIG. 6B.

The coupler for connecting reinforcing steel bars according to the present disclosure, which is configured as described above, operates as follows.

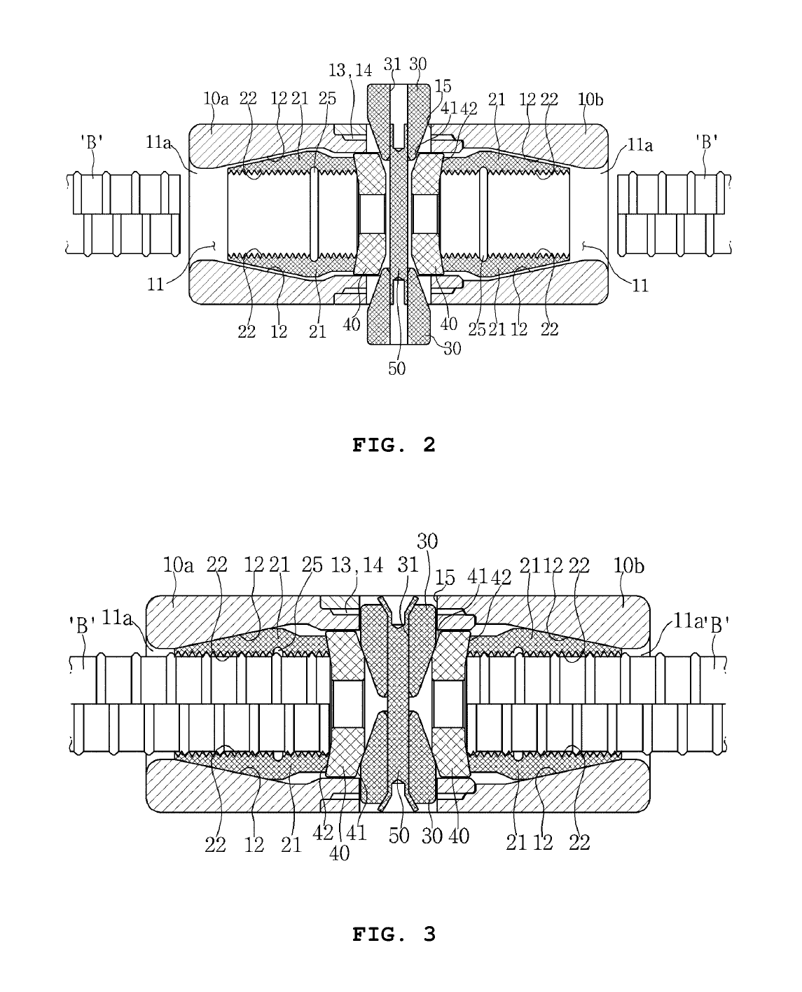

As shown in FIG. 2, a reinforcing steel bar B is inserted into the hollow part 11 through the inlet 11a formed at the one end portion of the first coupler body 10a, and a reinforcing steel bar B is inserted into the hollow part 11 through the inlet 11a formed at the one end portion of the second coupler body 10b.

At this point, the clampers 21 of the first clamping member 20a and the second clamping member 20b are finely widened by corresponding to diameters of the reinforcing steel bars B and the reinforcing steel bars B are in close contact with the clamping protrusions 22 provided on the inner surfaces of the clampers 21. Further, final end portions of the reinforcing steel bars B are in contact with the spacers 40 and then are stopped.

In addition, the fixing pin 50 is inserted through the through-holes 15 provided at both of the side surfaces of the first coupler body 10a and the second coupler body 10b, and the pin insertion hole 31 of the plurality of pressurizing members 30 are aligned to both of the end portions of the fixing pin 50 to fit the plurality of pressurizing members 30 into the fixing pin 50. At this point, the plurality of pressurizing members 30 are inserted inside the through-holes 15 of the first coupler body 10a and the second coupler body 10b, and the outer surfaces of the plurality of pressurizing members 30 are in contact with the receiving recesses 41 of the spacers 40.

In such a state, the plurality of pressurizing members 30 are completely pressed and fitted inside the hollow parts 11 through the through-holes 15 using the hydraulic device 60, wherein the plurality of pressurizing members 30 are first simultaneously pressurized using a first hydraulic pressure tool 63 illustrated in FIG. 6A and are pressed and fitted inside the through-holes 15 with a strong force. At this point, both of the end portions of the fixing pin 50 protrude to the outside of the plurality of pressurizing members 30, and are pressurized by a second hydraulic pressure tool 64 illustrated in FIG. 6B to be widened in a conical shape. As both of the end portions of the fixing pin 50 are conically widened, the plurality of pressurizing members 30 are fixed to the fixing pin 50 so that a spring back phenomenon in which the plurality of pressurizing members 30 escape to the outside of the fixing pin 50 does not occur.

When the plurality of pressurizing members 30 are pressed and fitted inside the through-holes 15 by the hydraulic device 60, the plurality of pressurizing members 30 are inserted inside the receiving recesses 41 of the spacers 40 to push the spacers 40 to the inlets 11a of the first coupler body 10a and the second coupler body 10b. Accordingly, the clampers 21 of the first clamping member 20a and the second clamping member 20b, which are in contact with the spacers 40, are moved to the inlets 11a and are tightly in close contact with the tapered parts 12, thereby being in close contact with the outer surfaces of the reinforcing steel bars B with a strong force.

Consequently, when a tensile force is applied to the reinforcing steel bars B and thus a force of which the reinforcing steel bars B escape to the outside of the first coupler body 10a and the second coupler body 10b is generated, the clampers 21 serve as a wedge to firmly hold the reinforcing steel bars B such that the reinforcing steel bars B are not separated from the first coupler body 10a and the second coupler body 10b.

As is described above, in accordance with the present disclosure, the plurality of pressurizing members 30 are pressed and fitted through the plurality of through-holes 15 formed on the side surfaces of the first coupler body 10a and the second coupler body 10b, and pressurize the first clamping member 20a and the second clamping member 20b to the tapered parts 12 with a strong force, and thus the first clamping member 20a and the second clamping member 20b serve as a wedge such that the reinforcing steel bars B are prevented from escaping. At this point, the plurality of pressurizing members 30 are firmly fixed to predetermined positions by the fixing pin 50 and thus are prevented from escaping to the outside of the through-holes 15 such that the spring back phenomenon does not occur and a phenomenon in which a force of the first clamping member 20a and the second clamping member 20b for fixing the reinforcing steel bars B is weakened does not occur.

In accordance with the present disclosure, the pressurizing members are pressed and fitted inside the first and second coupler bodies by the hydraulic device, and are firmly supported by the fixing pin to be prevented from escaping to the outside of the first and second coupler bodies such that a spring back phenomenon does not occur and a phenomenon in which a force of the first and second clamping members for fixing the reinforcing steel bars are weakened does not occur.

Although the present disclosure has been described in detail with reference to the embodiment, various substitutions, additions and modifications can be devised by those skilled in the art without departing from the above-described scope of the present disclosure, and it should be construed that such modified embodiments also fall within the scope of protection of the present disclosure as defined by the appended claims.

What is claimed is:

1. A coupler for coupling reinforcing steel bars, comprising:
a first coupler body and a second coupler body which include hollow parts having inlets formed at final end portions of the hollow parts and into which reinforcing steel bars are inserted, and having tapered parts of which each diameter gradually increases from the inlet to a side opposite thereto, and a plurality of through-holes formed to face each other at side surfaces of the first coupler body and the second coupler body;
a first clamping member and a second clamping member which are configured with a plurality of clampers having outer surfaces installed to be in contact with the tapered parts inside the hollow parts of the first and second coupler bodies, and at which a plurality of clamping protrusions are disposed on inner surfaces of the plurality of clampers to hook and support nodes of the reinforcing steel bars;
two pressurizing members having a conical shape and a pin insertion hole formed to pass through central portions of each of the two pressurizing members, inserted through the plurality of through-holes by a hydraulic device, and configured to pressurize the first clamping member and the second clamping member to the inlets and tightly contact the first clamping member and the second clamping member to the tapered parts; and
a fixing pin configured in a rod shape, inserted through the pin insertion hole of the two pressurizing members, and configured to simultaneously support the two pressurizing members,
wherein both end portions of the fixing pin protrude outside the two pressurizing members and are widened to have a conically widened shape so as to simultaneously support the two pressurizing members while preventing the two pressurizing members from escaping from the fixing pin.

2. The coupler of claim 1, further comprising ring-shaped spacers installed between final end portions of the first clamping member and the second clamping member, and side surfaces of the two pressurizing members, and including receiving recesses configured to have a shape corresponding to the side surfaces of the two pressurizing members and to be in close contact with the side surfaces thereof.

3. The coupler of claim 2, wherein one surfaces of the spacers, which are in contact with the final end portions of the first clamping member and the second clamping member, are formed to be inclined toward the two pressurizing members as being toward an inner side of a radius direction.
